(19) United States
(12) Patent Application Publication
(10) Pub. No.: US 2026/0189765 A1
(43) Pub. Date: Jul. 2, 2026

(54) CONTROL APPARATUS, VIDEO TRANSMISSION SYSTEM, CONTROL METHOD, AND PROGRAM

(71) Applicant: NTT, Inc, Tokyo (JP)

(72) Inventors: Hiroyuki KITADA, Tokyo (JP); Takafumi OKUYAMA, Tokyo (JP); Xiaotian ZHAO, Tokyo (JP)

(73) Assignee: NTT. Inc., Tokyo (JP)

(21) Appl. No.: 18/857,775

(22) PCT Filed: Apr. 20, 2022
(86) PCT No.: PCT/JP2022/018337

§ 371 Date: Oct. 17, 2024

(51) Int. Cl. H04N 21/647; H04N 21/6405

(52) U.S. Cl. CPC H04N 21/64707; H04N 21/6405

(57) ABSTRACT

There is provided a control device that executes control in a network including a video processing unit that performs processing on video data sent from a video sending device and a network device that performs transfer processing of the video data, the control device including a processing determination unit that determines video processing in the video processing unit and transfer processing using multicast in the network device, based on a plurality of items of predetermined layout information and layout information selected by each client terminal from the plurality of items of layout information.

### TECHNICAL FIELD

The present invention relates to a technology for performing video streaming to a client terminal.

### BACKGROUND ART

Live video streaming is widely used. In addition, there are services that require ultra-low latency streaming. However, in video compression technologies such as the general H.265 and H.264, not only does an encoding or decoding process have certain latency, but also processing such as video switching or video synthesis may have further latency.

In recent years, there has been a protocol for transmitting an uncompressed video represented by ST2110 and a light compressed video close to an uncompressed video. The protocol has high affinity with video production and can transmit a high-quality video with low latency as compared with transmission by a general compressed video.

In the future, with the development of network technology, it is considered that a several-Gbps level video will be able to be delivered to a user. At that time, by applying a protocol such as ST2110 that has been mainly used in the video production field to video streaming, end-to-end ultra-low latency streaming will be able to be realized.

Further, in recent years, there has also been a technology of replacing a video by performing packet-based processing on ST2110 (for example, Non Patent Literature 1 and Non Patent Literature 2). In the technology, a frame number and position information of a pixel included in a payload written in a packet header are identified, and processing such as discarding of a packet or rewriting of a header is performed by a network device, thereby implementing a video switching or synthesis processing by the packet-based processing. Consequently, low-latency video streaming and video processing can be performed by the network device alone without using dedicated video editing equipment.

In addition, diversification of needs of users who view videos also results in a demand for provision of more personalized video services. Hitherto, only transmission of prepackaged video data has been performed in a network; however, by utilizing the above-described technology, video streaming personalized to individual users can also be realized in a network.

### CITATION LIST

### Non Patent Literature

Non Patent Literature 1: Paul Briscoe, “Efficient Carriage of Sub-Rasters With ST 2110-20”, IP SHOWCASE THEATRE AT IBC2019: 13-17 Sep. 2019.
Non Patent Literature 2: Kitada, Fukudome, Okuyama, Zhao, Kurozumi, Nishide, Nishimura, Nishimoto, “Kei asshuku eizo no nettowaku-nai eizo shori hoshiki ni kansuru ichi kento (In Japanese) (Study on method for processing light compressed video in network)” The Institute of Electronics, Information and Communication Engineers 2022 General Conference B-6-26, March 2022.

### SUMMARY OF INVENTION

### Technical Problem

When packet-based video processing is performed utilizing a technology such as ST2110, video data communication to each user is normally performed in the order of an encoder, a video processing unit, and a decoder. At this time, when streaming personalized for each user is performed, it is necessary to change the content of video processing according to various video processing requests. In this case, it is necessary to prepare video processing functions for the number of clients and secure bandwidths for the number of clients. This requires a very large amount of resources.

The present invention has been made in view of the above-described points, and an object of the present invention is to provide a technology for reducing resources required for video processing and video transmission when video streaming personalized to individual users is performed.

### Solution to Problem

According to the disclosed technology, there is provided a control device that executes control in a network including a video processing unit that performs processing on video data sent from a video sending device and a network device that performs transfer processing of the video data, the control device including a processing determination unit that determines video processing in the video processing unit and transfer processing using multicasting in the network device, based on a plurality of items of predetermined layout information and layout information selected by each client terminal from the plurality of items of layout information.

### Advantageous Effects of Invention

According to the disclosed technology, there is provided a technology for reducing resources required for video processing and video transmission when video streaming personalized to individual users is performed.

### BRIEF DESCRIPTION OF DRAWINGS

FIG. 1 is a diagram illustrating an overall configuration example of a system.

FIG. 2 is a diagram illustrating a configuration example of a controller 120.

FIG. 3 is a diagram illustrating an example of layout information.

FIG. 4 is a diagram illustrating an example of client terminal information.

FIG. 5 is a diagram illustrating an example of video data information.

FIG. 6 is a diagram illustrating a configuration example of a network device 110.

FIG. 7 is a diagram illustrating a configuration example of a video processing unit 130.

FIG. 8 is a flowchart of Example 1.

FIG. 9 is a flowchart of Example 2.

FIG. 10 is a diagram illustrating an example of a multicast tree.

FIG. 11 is a diagram illustrating an example of a multicast tree.

FIG. 12 is a diagram illustrating examples of setting parameters of the video processing unit 130.

FIG. 13 is a diagram illustrating examples of setting parameters of the network device 110.

FIG. 14 is a diagram illustrating a hardware configuration example of a device.

### DESCRIPTION OF EMBODIMENTS

Hereinafter, embodiments (present embodiments) of the present invention will be described with reference to the drawings. Each of the embodiments to be described below is merely an example, and the embodiments to which the present invention is applied are not limited to the following embodiments.

### (System Configuration)

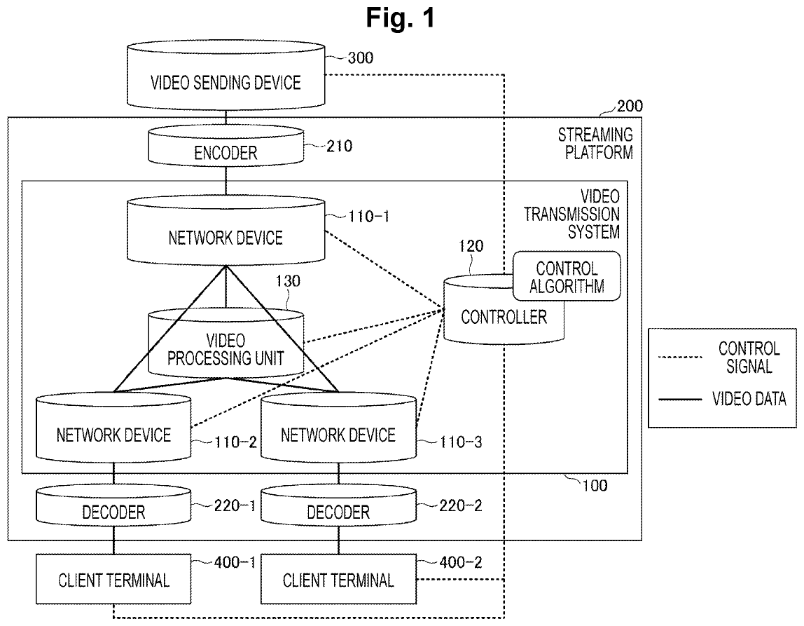

FIG. 1 illustrates an overall configuration example of a system according to the present embodiment. As illustrated in FIG. 1, in this system, a video transmission system 100 is provided in a streaming platform 200.

The video transmission system 100 includes network devices 110-1 to 110-3, a controller 120, and a video processing unit 130. Note that the video transmission system 100 may not include the network devices 110-1 to 110-3. The controller 120 and the video processing unit 130 may be referred to as a control device 120 and a video processing device 130, respectively.

An encoder 210 or a decoder 220 is connected to each network device 110 at a position illustrated in FIG. 1. In addition, a video sending device 300 and the client terminals 400-1 and 400-2 are present. Each device can communicate with another device via a network (for example, an IP network).

The number of individual devices illustrated in FIG. 1 is an example. For example, a plurality of video sending devices 300 are generally present. In addition, in the present embodiment, the video sending device 300 is assumed to be a device of a content provider. The video sending device 300 may be referred to as a video source.

In this system, as an example, video transmission is performed using a protocol for transmitting an uncompressed video represented by ST2110 or a light compressed video close to an uncompressed video. As an example, in ST2110, a plurality of pixels are converted into IP packets. The video processing unit 130 can determine a pixel from information of a packet by a function of a programmable switch or the like with respect to streaming of the packet transmitted from the video sending device 300 and performs rewriting or the like of a header, thereby performing synthesis or the like of videos in a network. Note that the video processing unit 130 may be the network device 110. That is, the network device 110 may include a function of the video processing unit 130.

The network device 110 is a device capable of performing packet transfer of a router, a switch, or the like.

The encoder 210 is a device that encodes a video. The decoder 220 is a device that decodes encoded video data to obtain a video.

The controller 120 executes a control algorithm (control program) to determine video processing contents and transfer processing contents. The controller 120 may be referred to as a control device.

The client terminal 400 is a device of a video viewing user such as a PC, a tablet, or a smartphone. The client terminal 400 may be a CPE in which a plurality of terminals are connected under control.

In the present embodiment, it is assumed that a viewing user selects a desired pattern within a range of video processing patterns permitted in advance by a content provider. Under this assumption, the system having the above-described configuration groups video processing for each viewing user and performs processing for each group and performs path control by transmitting each item of video data and multicasting video processing for each item of video data, thereby implementing a control technique of achieving both the video processing and the video transmission.

Note that, in the present exemplary embodiment, a method of video processing (resizing or synthesis) executed by the video processing unit 130 is not limited to a specific method, and for example, the method disclosed in Non Patent Literature 2 can be used. As an example, videos of a video source a can be synthesized with a video source b by replacing header information of a part of a video packet in the video source b with header information of a video packet of the video source a.

In addition, each unit or each device in the video transmission system may be a physical device or a virtual machine on a virtual infrastructure.

Hereinafter, a configuration of each device (each unit) will be described. Detailed operations will be described in the following Examples 1 and 2.

### (Controller 120)

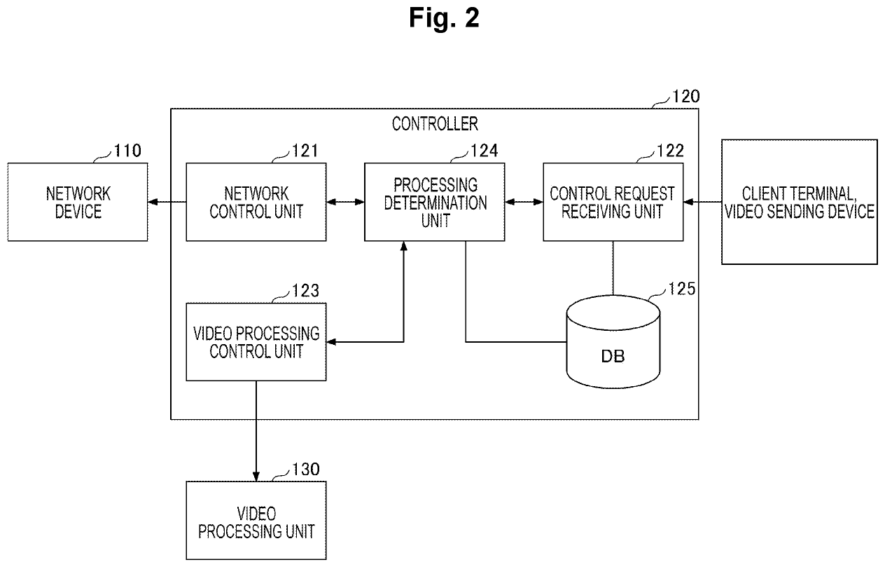

FIG. 2 illustrates a configuration of the controller 120. As illustrated in FIG. 2, the controller 120 includes a network control unit 121, a control request receiving unit 122, a video processing control unit 123, a processing content determining unit 124, and a DB 125.

The network control unit 121 sets transfer processing contents for each network device 110. The video processing control unit 123 sets video processing contents to the video processing unit 130. Note that the network control unit 121 and the video processing control unit 123 may be collectively referred to as a “control unit”. In addition, the network control unit 121 and the video processing control unit 123 may be provided outside the controller 120.

The control request receiving unit 122 communicates with the client terminals 400 and the video sending device 300. The processing content determining unit 124 determines video processing contents and resources in the video processing unit 130 and processing contents in the network device 110.

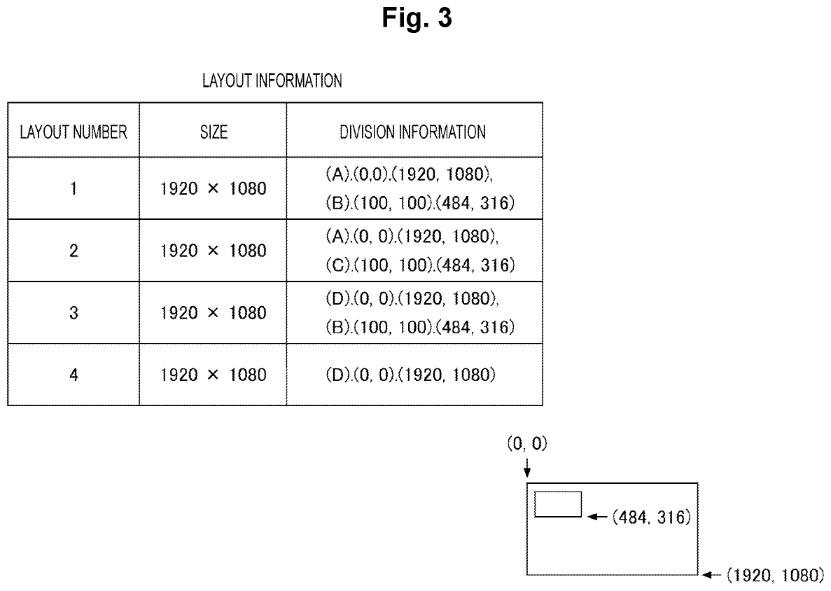

The database (DB) 125 stores various items of data. Examples of data (parameters) stored in the database (DB) 125 are illustrated in FIGS. 3 to 5. A usage example of each data will be described in Examples to be described below.

FIG. 3 illustrates an example of layout information. As illustrated in FIG. 3, the layout information includes a layout number, a size, and division information. The division information includes the following information with the upper left point of a video as an origin (0, 0) of coordinates.

“(Identifier of video sending device). (Display coordinate origin). (Display coordinate ending point),”

In a case where a plurality of videos are superimposed and synthesized, the videos are written in an order from a back surface by being separated with commas. An example illustrated in the lower right of FIG. 3 indicates the division information of a layout number=1.

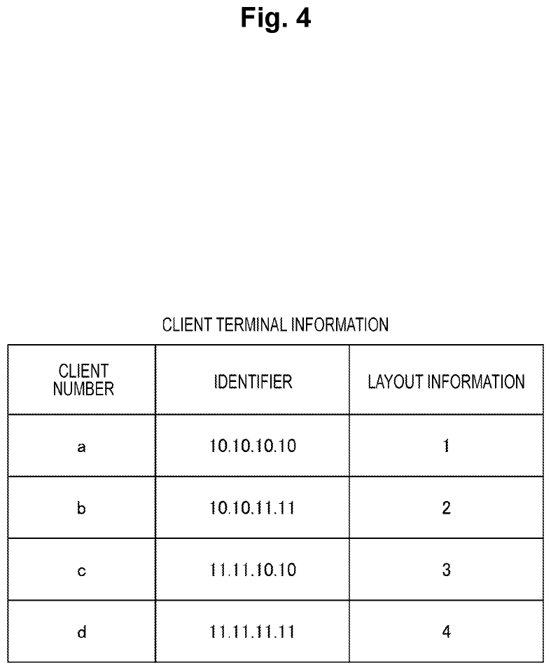

FIG. 4 illustrates an example of the client terminal information. As illustrated in FIG. 4, the client terminal information includes a client number, an identifier of the client terminal, and layout information (number) selected in the client terminal. Note that, in FIG. 4, for convenience of illustration, the layout information is different for each client terminal, but actually, it is assumed that a plurality of client terminals select one item of layout information.

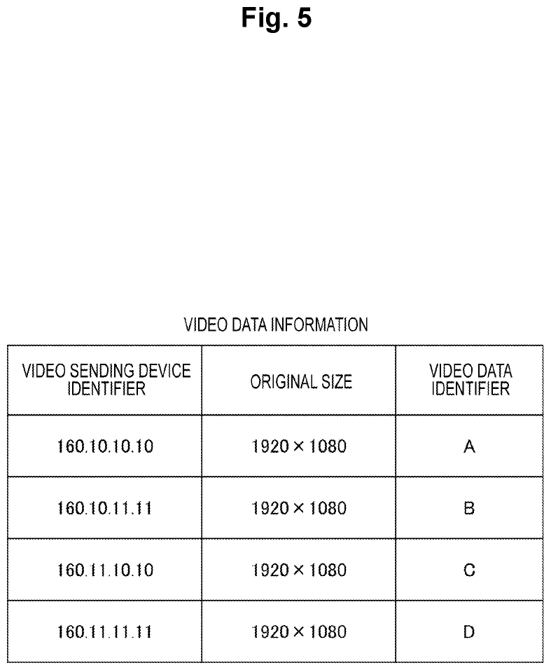

FIG. 5 illustrates an example of video data information. This video data information is information that the controller 120 acquires in advance from each video sending device 300. As illustrated in FIG. 5, the video data information includes a video sending device identifier, an original size of video data, and a video data identifier.

### (Network Device 110)

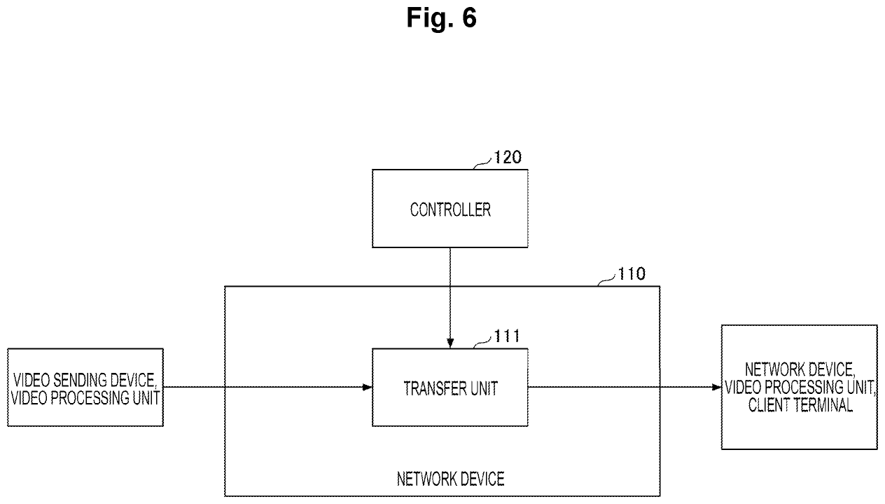

FIG. 6 illustrates a configuration of the network device 110. As illustrated in FIG. 6, the network device 110 includes a transfer unit 111. The transfer unit 111 transfers video data (packet) received from a certain device to another device depending on the transfer processing contents set from the controller 120.

### (Video Processing Unit 130)

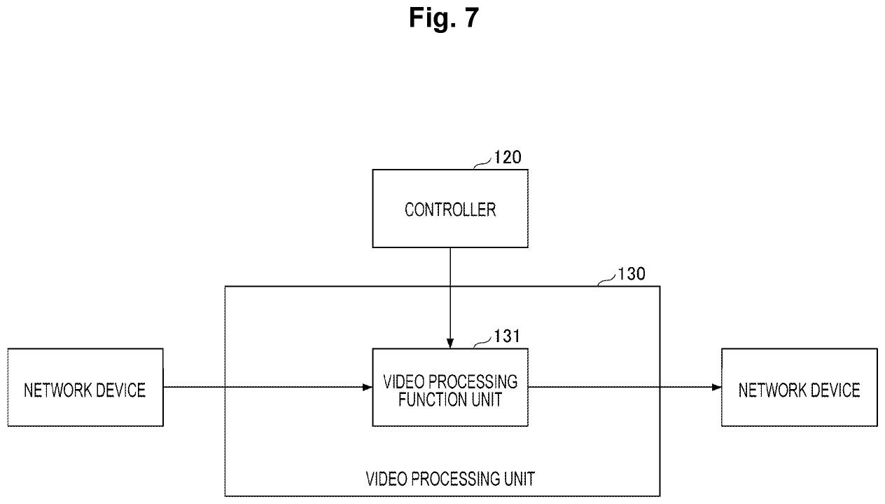

FIG. 7 illustrates a configuration of the video processing unit 130. As illustrated in FIG. 7, the video processing unit 130 includes a video processing function unit 131. The video processing function unit 131 performs processing on a packet received from a certain network device depending on the video processing contents set from the controller 120 and transfers the processed packet to another network device.

Hereinafter, Example 1 and Example 2 will be described regarding operations of the system having the above-described configuration. Example 2 is a detailed example of processing in the processing determination unit 124. The control described in Example 1 and Example 2 is dynamically performed in response to a request (selection) from the client terminal 400.

### Example 1

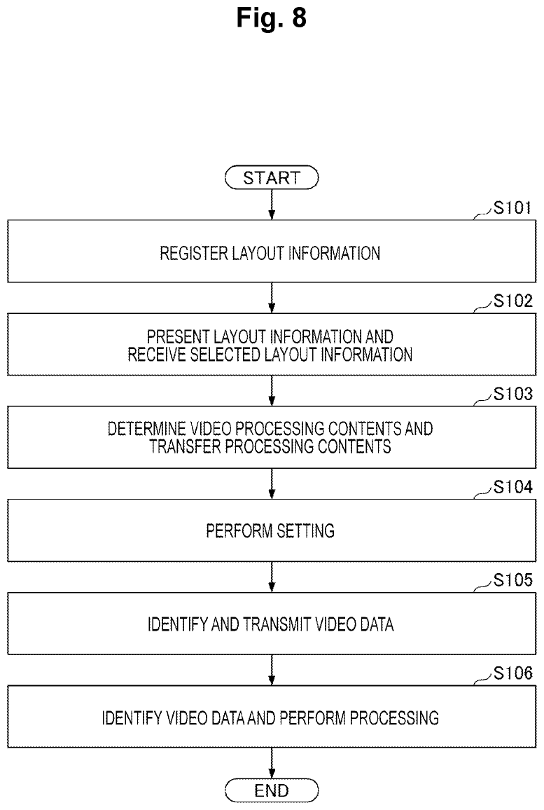

Example 1 will be described following the procedure of the flowchart of FIG. 8. In S101, the control request receiving unit 122 in the controller 120 receives layout information from the video sending device 300 (contents provider) and registers the received layout information in the DB 125. An example of the registered layout information is illustrated in FIG. 3.

In S102 of FIG. 8, the control request receiving unit 122 of the controller 120 reads the registered layout information from the DB 125 and presents the registered layout information to the client terminal 400.

In the client terminal 400, a certain item of layout information is selected and notified to the controller 120. The control request receiving unit 122 receives the selected layout information. The received layout information is registered as client terminal information in the DB 125. An example of the client terminal information is illustrated in FIG. 4.

In S103, the processing determination unit 124 of the controller 120 determines video processing contents in the video processing unit 130 and transfer processing contents in the network devices 110-1 to 110-3 by a control algorithm from the client terminal information and the layout information. The determined processing contents are passed to the network control unit 121 and the video processing control unit 123.

In S104, the network control unit 121 sets the transfer processing contents determined in S103 for each network device 110 as a setting target, and the video processing control unit 123 sets the video processing contents determined in S103 for each video processing unit 130 as a setting target.

In S105, when the transfer unit 111 of the network device 110 receives the video data from the encoder 210 (or another network device), the transfer unit 111 identifies the video data on the basis of the processing contents set from the controller 120 and transmits the video data to the video processing unit 130 (alternatively, another network device or a decoder) set for the identified video data.

In S106, when the video processing unit 130 receives the video data from the network device 110, the video processing unit 130 identifies the video data on the basis of the processing contents set from the controller 120, performs processing, and transmits the video data to the next network device.

### Example 2

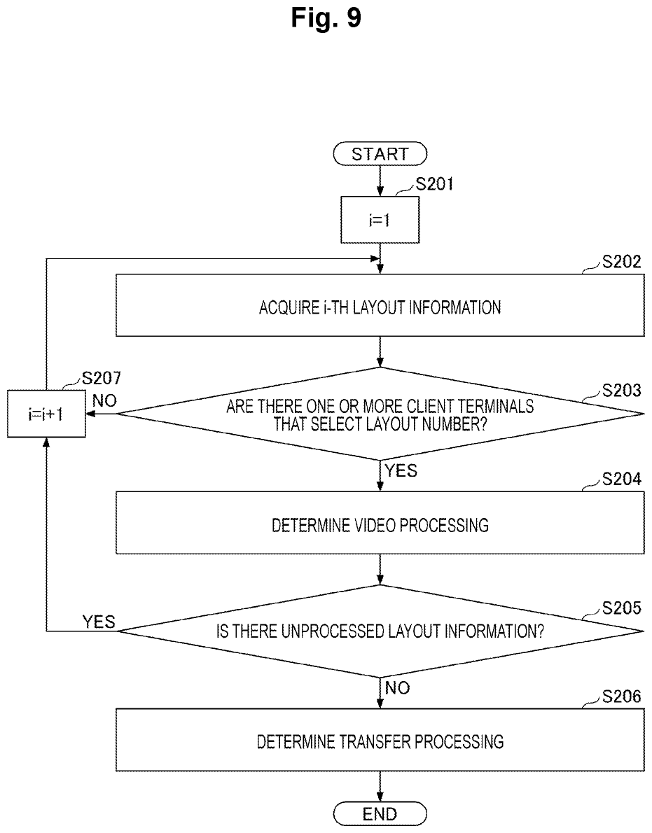

Next, as Example 2, determination processing of the video processing contents and the transfer processing contents in the controller 120 will be described with reference to a flowchart of FIG. 9. It is assumed that the DB 125 stores layout information (for example, FIG. 3), client terminal information (for example, FIG. 4), and video data information (for example, FIG. 5). In addition, it is assumed that the DB 125 also stores network configuration information necessary for determining the transfer processing contents. The processing determination unit 124 can use the network configuration information to construct a multicast tree and the like as will be described below.

In the flow of FIG. 9, S202 to S205 are executed for each item of registered layout information (layout number). In S201, the processing determination unit 124 initializes i indicating the layout number to 1.

In S202, the processing determination unit 124 acquires i-th layout information from the DB 125.

In S203, the processing determination unit 124 compares the layout information acquired in S202 with the client terminal information in the DB 125 and determines whether there are one or more client terminals that select the layout information acquired in S202. For example, in the case of the layout number=1 in FIG. 3, the client number=a in FIG. 4 corresponds thereto.

In S204, the processing determination unit 124 determines the video processing contents. First, the processing determination unit 124 determines processing for the video data included in the division information, from the division information of the i-th layout information and the video data information. Specific examples are as follows.

In a case where the division information is configured of only one item of video data, and a size of the video data in the layout information indicated by the division information is not different from an original size, the processing determination unit 124 determines not to perform the video processing.

The processing determination unit 124 determines to perform resizing processing on the video data in which the division information is configured of only one item of video data and the size of the video data in the layout information indicated by the division information is different from the original size.

In a case where the division information is configured of a plurality of items of video data, the processing determination unit 144 determines to perform synthesis processing.

Note that the above description is provided as an example, and processing other than resizing and synthesis may be performed.

If there is unprocessed layout information, i has an increment and the above-described processing is performed on the next layout information (Yes in S205), and if there is no unprocessed layout information (No in S205), the processing proceeds to S206.

In S206, the processing determination unit 125 determines the transfer processing contents. Details are as follows.

First, the processing determination unit 124 constructs a multicast tree between individual video sources (video sending devices) requested from client terminals and the client terminals as request sources on the basis of the layout information, the client terminal information, a video processing determination result in S206, and the like.

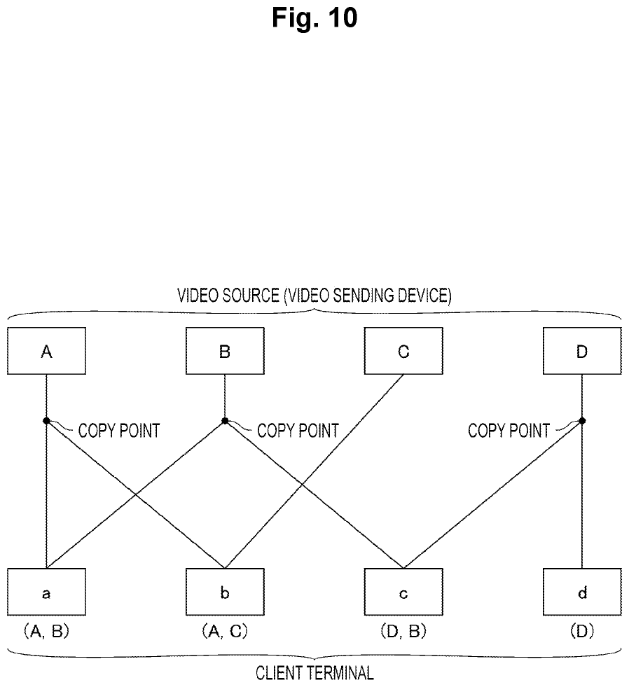

As an example, FIG. 10 illustrates an example of the multicast tree in a case where the client terminal information illustrated in FIG. 4 is obtained under the layout information illustrated in FIG. 3. In FIG. 10, a capital letter A or the like indicates video sources. A small letter a or the like indicates a client terminal. For example, (A, B) or the like below the client terminal indicates that a video of A and a video of B are requested for the client terminal a. The same applies to other client terminals.

In addition, black circles (branch points of the tree) in the drawing represent copy points (network devices functioning as copy points) of the multicast tree. That is, the video data sent from the video sending device 300 is copied at the copy point and transferred to each branching destination.

Note that, for convenience of illustration, FIG. 10 illustrates an example in which one client terminal is connected for each pattern such as (A, B). However, in general, a plurality of client terminals are connected for each pattern such as (A, B), and each client terminal receives a corresponding video via a decoder.

Next, the processing determination unit 124 selects the video processing unit 130 close to the copy point of the multicasting for each video source. Note that one video processing unit 130 may be selected for one video source, or one video processing unit 130 may be selected for a plurality of video sources.

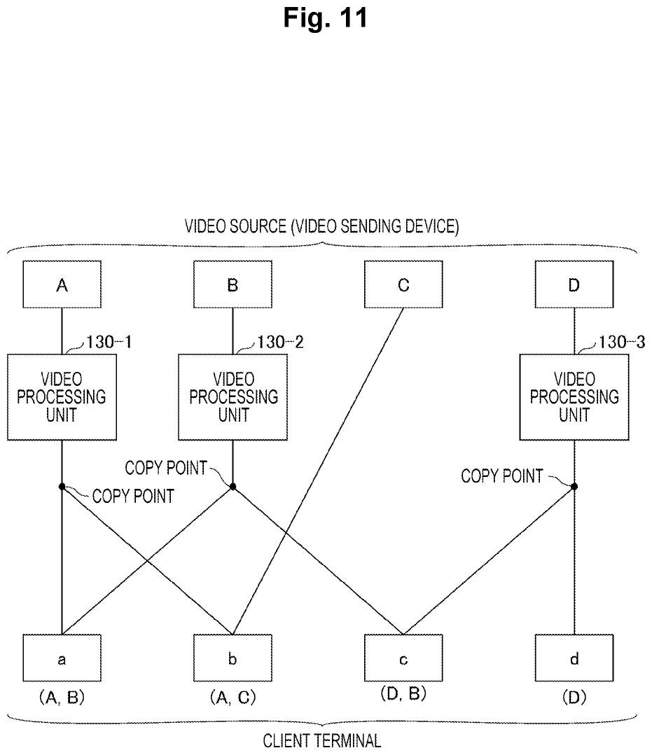

In addition, for example, in a case where the video processing unit 130 is realized by a virtual machine, or the like, resources to be allocated to the video processing unit 130 (virtual machine) may be increased or decreased depending on the number of video sources processed by the video processing unit 130. That is, the larger the number of video sources, the larger the resource amount is allocated. FIG. 11 illustrates an image in which three video processing units 130-1 to 130-3 are selected with respect to the state of FIG. 10.

“Selecting a video processing unit close to a copy point of multicasting” refers to, for example, a video processing unit closest to copy point 1, of three video processing units, in a case where the three video processing units are present focusing on copy point 1. In addition, “close to a copy point” may mean that a physical distance is short or a network distance is short (for example, the number of passing network devices is minimum).

Next, the video processing control unit 123 sets processing contents, a video sending device identifier of video data that needs to be processed, and information of a transmission destination together in the video processing unit 130 on the basis of a result of the video processing determination in S204.

In addition, in the video transmission system, in a case where video data is sent to the video processing unit 130, a path is set so that the video data reaches a network device of a copy point from another network device immediately before the copy point (video source side) via the video processing unit 130. However, the path setting is an example. In the path setting, the network control unit 121 sets a setting parameter in each network device 110 such that a desired path is established.

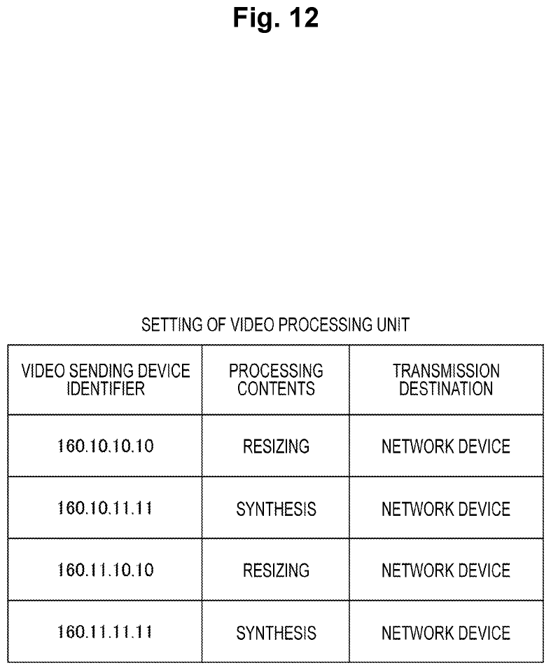

FIG. 12 illustrates examples of setting parameters of the video processing unit 130. The examples indicate examples in a case where a certain video processing unit 130 performs processing on video data of four video sending devices. For example, FIG. 12 illustrates that the video data transmitted from the video sending device of 160.10.10.10 is resized and transferred to the network device of the copy point.

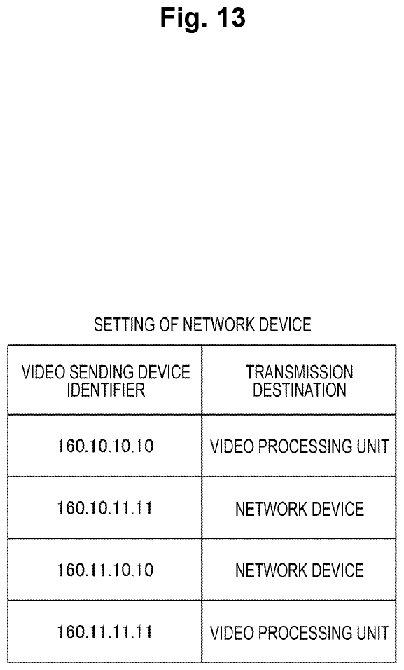

FIG. 13 illustrates examples of setting parameters of a certain network device 110. For example, this example indicates that video data transmitted from the video sending device of 160.10.10.10 is transferred to the video processing unit 130, and video data transmitted from a video sending device of 160.10.11.11 is transferred to another network device.

In the example of FIG. 11, for example, regarding the video processing unit 130-1, a packet obtained by performing synthesis processing of (A, B) and a packet obtained by performing synthesis processing of (A, C) on the video data (packet) from the video source A are generated, and these packets are sent to the network device of the copy point.

With respect to the client terminal a, a video subjected to the synthesis processing of (A, B) is distributed to the client terminal a by a decoder present before the client terminal a. With respect to the client terminal b, a video subjected to the synthesis processing of (A, C) is distributed to the client terminal b by a decoder present before the client terminal b.

### Hardware Configuration Example

The network device 110, the controller 120, and the video processing unit 130 according to the present embodiment can all be realized by causing a computer to execute a program, for example. This computer may be a physical computer, or may be a virtual machine on a cloud. In a case where a virtual machine on a cloud is used, the configuration to be described below is a virtual configuration. Hereinafter, the network device 110, the controller 120, and the video processing unit 130 are collectively referred to as “devices”.

That is, the device can be realized by a program corresponding to processing performed by the device being executed by use of hardware resources such as a CPU and a memory built in the computer. The above program can be stored and distributed by being recorded in a computer-readable recording medium (portable memory or the like). In addition, the program can be provided via a network such as the Internet or electronic mail.

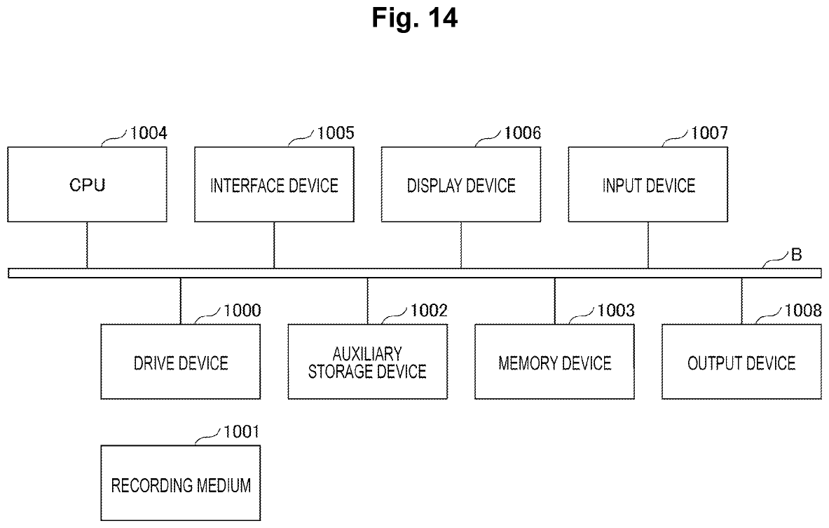

FIG. 14 is a diagram illustrating a hardware configuration example of the computer. The computer in FIG. 14 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. Note, however, that the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 implements a function related to the device in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Effects of Embodiments

According to the technology of the present embodiments, resources of video processing performance can be reduced by grouping and executing video processing, and video streaming can be performed with minimum network band resources by dynamic control of video processing resources and a transmission path.

### (Supplementary Notes)

Regarding the above-described embodiments, the following supplementary notes are further disclosed.

### (Supplementary Note 1)

A control device that executes control in a network including a video processing unit that performs processing on video data sent from a video sending device and a network device that performs transfer processing of the video data, the control device including:

a processing determination unit that determines video processing in the video processing unit and transfer processing using multicast in the network device, based on a plurality of items of predetermined layout information and layout information selected by each client terminal from the plurality of items of layout information.

### (Supplementary Note 2)

The control device according to Supplementary Note 1, further including

a controller that executes setting of the video processing to the video processing unit and setting of the transfer processing to the network device.

### (Supplementary Note 3)

The control device according to Supplementary Note 1 or 2, in which

the processing determination unit determines the video processing for each item of layout information selected by at least one client terminal.

### (Supplementary Note 4)

The control device according to any one of Supplementary Notes 1 to 3, in which

the processing determination unit constructs a multicast tree between each video source of video data constituting layout information selected by at least one client terminal and a plurality of client terminals as selection sources and determines the transfer processing such that video data reaches, via the video processing unit, a network device serving as a copy point in the multicast tree.

### (Supplementary Note 5)

A video transmission system including: the control device according to any one of Supplementary Notes 1 to 4; and the video processing unit.

### (Supplementary Note 6)

A control method in a control device that executes control in a network including a video processing unit that performs processing on video data sent from a video sending device and a network device that performs transfer processing of the video data, the control method including:

determining video processing in the video processing unit and transfer processing using multicast in the network device, based on a plurality of items of predetermined layout information and layout information selected by each client terminal from the plurality of items of layout information.

### (Supplementary Note 7)

A non-transitory storage medium storing a program for causing a computer to function as each unit in the control device according to any one of Supplementary Notes 1 to 4.

While the present embodiments have been described above, the present invention is not limited to such specific embodiments, and various modifications and changes can be made within the scope of the spirit of the present invention described in the claims.

### REFERENCE SIGNS LIST

100 Video transmission system
200 Streaming platform
110 Network device
111 Transfer unit
120 Controller
121 Network control unit
122 Control request receiving unit
123 Video processing control unit
124 Processing content determining unit
125 DB
130 Video processing unit
131 Video processing function unit
210 Encoder
220 Decoder
300 Video sending device
400 Client terminal
1000 Drive device
Recording medium
1002 Auxiliary storage device
1003 Memory device
1004 CPU
1005 Interface device
1006 Display device
1007 Input device
1008 Output device

1. A control device that executes control in a network including a video processing unit that performs processing on video data sent from a video sending device and a network device that performs transfer processing of the video data, the control device comprising:
a processing determination unit that determines video processing in the video processing unit and transfer processing using multicast in the network device, based on a plurality of items of predetermined layout information and layout information selected by each client terminal from the plurality of items of layout information.

2. The control device according to claim 1, further comprising
a controller that executes setting of the video processing to the video processing unit and setting of the transfer processing to the network device.

3. The control device according to claim 1, wherein
the processing determination unit determines the video processing for each item of layout information selected by at least one client terminal.

4. The control device according to claim 1, wherein
the processing determination unit constructs a multicast tree between each video source of video data constituting layout information selected by at least one client terminal and a plurality of client terminals as selection sources and determines the transfer processing such that video data reaches, via the video processing unit, a network device serving as a copy point in the multicast tree.

5. A video transmission system comprising:
the control device according to claim 1; and the video processing unit.

6. A control method in a control device that executes control in a network including a video processing unit that performs processing on video data sent from a video sending device and a network device that performs transfer processing of the video data, the control method comprising:
determining video processing in the video processing unit and transfer processing using multicast in the network device, based on a plurality of items of predetermined layout information and layout information selected by each client terminal from the plurality of items of layout information.

7. (canceled)

8. The control method according to claim 6, further comprising
executing setting of the video processing to the video processing unit and setting of the transfer processing to the network device.

9. The control method according to claim 6, wherein
determining the video processing for each item of layout information selected by at least one client terminal.

10. The control method according to claim 6, wherein
constructing a multicast tree between each video source of video data constituting layout information selected by at least one client terminal and a plurality of client terminals as selection sources and determines the transfer processing such that video data reaches, via the video processing unit, a network device serving as a copy point in the multicast tree.

11. A computer-readable non-transitory recording medium storing computer-executable program instructions that when executed by a processor cause a computer to execute a control method comprising:
executing control in a network including a video processing unit that performs processing on video data sent from a video sending device and a network device that performs transfer processing of the video data, the control method comprising:
determining video processing in the video processing unit and transfer processing using multicast in the network device, based on a plurality of items of predetermined layout information and layout information selected by each client terminal from the plurality of items of layout information.

12. The computer-readable non-transitory recording medium according to claim 11 wherein the control method further comprises:
executing setting of the video processing to the video processing unit and setting of the transfer processing to the network device.

13. The computer-readable non-transitory recording medium according to claim 11 wherein the control method further comprises:
determining the video processing for each item of layout information selected by at least one client terminal.

14. The computer-readable non-transitory recording medium according to claim 11 wherein the control method further comprises:
constructing a multicast tree between each video source of video data constituting layout information selected by at least one client terminal and a plurality of client terminals as selection sources and determines the transfer processing such that video data reaches, via the video processing unit, a network device serving as a copy point in the multicast tree.

15. The control device according to claim 1, wherein
video processing for each viewing user is grouped and performs route control using multicast for transmission and video processing for each video data in the group.

16. The control device according to claim 1, wherein
the video processing unit replaces header information of video packets in a first video source with header information of a second video packets and combines the first video source with the second video source.

17. The control device according to claim 1, wherein
each part or each device in the video transmission system may be a physical device or a virtual machine on a virtual infrastructure.
